(19) United States
(12) Patent Application Publication
(10) Pub. No.: US 2009/0201786 A1
(43) Pub. Date: Aug. 13, 2009

(54) OPTICAL ELEMENT AND OBJECTIVE OPTICAL SYSTEM

(75) Inventor: Yoshiyuki TASHIRO, Kanagawa (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/368,533

(22) Filed: Feb. 10, 2009

(30) Foreign Application Priority Data
Feb. 12, 2008 (JP) 2008-030061

(51) Int. Cl. G11B 7/00

(52) U.S. Cl. 369/112.01; G9B/7

(57) ABSTRACT

There is provided an optical element for an objective optical system of an optical information recording/reproducing device. The objective optical system is configured to satisfy conditions: λ<500; NA≧0.7; and f≦1.0, and at least one of surfaces of the optical element includes a diffraction structure defined by an optical path difference function φ(h):

φ(h)=(P₂h²+P₄h⁴+P₆h⁶+P₈h⁸+P₁₀h¹⁰+P₁₂h¹²)mλ
where P₂, P₄, P₆ . . . denote coefficients of 2^{nd} order, 4^{th} order, 6^{th} order . . . , respectively, h denotes a height from an optical axis of the optical element, and m denotes a diffraction order at which diffraction efficiency for the laser beam is maximized. The diffraction structure satisfies conditions:

P₂<0 (4);

P₂×P₄<−100 (5); and

−60<P₂/P₄<0 (6).

### BACKGROUND OF THE INVENTION

The present invention relates to an optical element for correcting longitudinal chromatic aberration and an objective optical system to be mounted on an optical information recording/reproducing device.

In general, an optical information recording/reproducing device is configured to converge a laser beam emitted by a light source onto a record surface of an optical disc, such as DVD. The laser beam reflecting from a record surface of the optical disc returns along the same optical path along which the laser beam emitted by the light source proceeds to the optical discs. The returning laser beam is directed to a photoreceptor unit after being deflected by a beam splitter located between the light source and an objective lens. Incidentally, in this specification, the “optical information recording/reproducing devices” include devices for both information reproducing and information recording, devices exclusively for information reproducing, and devices exclusively for information recording.

An example of an objective lens for such an optical information recording/reproducing device is disclosed in Japanese Patent Publication No. 3563747 (hereafter, referred to as JP3563747).

The objective lens disclosed in JP3563747 is mounted on an optical information recording/reproducing device capable of executing information recording or information reproducing for existing optical discs, such as CD and DVD. Further, the objective lens is configured to correct spherical aberration caused when the wavelength of the laser beam emitted by the light source varies by a minute amount due to, for example, temperature variations, through the optical effect of a diffraction structure formed on one of surfaces of the objective lens.

In order to realize a larger storage capacity, an optical disc having a higher recording density, such as HD DVD or BD (Blu-ray Disc), has been brought into practical use. For information recording or information reproducing for optical discs, it is required to achieve a suitable diameter of a beam spot suitable for a recording density of an optical disc being used by changing the wavelength of the laser beam being used or the numerical aperture (NA). In general, the beam spot diameter decreases as the wavelength of the laser beam decreases or the NA increases. Therefore, for the information recording or the information reproducing for the optical disc having the higher recording density, a laser beam (i.e., so-called blue laser) having a relatively short wavelength (e.g., around 400 nm) is used and the NA is set to have a high value.

If the objective lens disclosed in JP3563747 is used to suppress the chromatic aberration which may be caused during the information recording or the information reproducing for the optical disc having the higher recording density, the following drawbacks occur.

A diffraction surface for correcting the chromatic aberration is provided with a plurality of annular zones (refractive surface zones) concentrically formed about an optical axis of the objective lens. The density of the annular zones becomes higher at a portion closer to the periphery of the objective lens, and therefore the width of each annular zone in the direction perpendicular to the optical axis becomes narrower at a position closer to the periphery of the objective lens. Therefore, if an objective lens for information recording or information reproducing for the optical disc having the higher recording density is designed in accordance with the configuration of the objective lens disclosed in JP3563747, the width of an annular zone near the periphery of the objective lens becomes too narrow and thereby the amount of transmitted light decreases considerably. Decrease of the amount of transmitted light leads to decrease of the light amount of a beam spot formed on the record surface of the optical disc, which is a serious hindrance for performing information recording or information reproducing with a high degree of accuracy.

Recently, a device for achieving a still higher information storage capacity by utilizing a near field optical recording technology has been proposed. It is thought that such a device utilizing the near field optical recording technology is able to execute information recording and/or information reproducing for a next-generation optical disc having a still higher storage capacity and a still higher recording density than those of HD DVD and BD. The device utilizing the near field optical recording technology requires a still shorter wavelength and a still higher NA than those for HD DVD and BD. Therefore, if such devices are brought into practical use, the above described drawbacks will come to the fore.

In the device utilizing the near field optical recording technology, if the longitudinal chromatic aberration of an objective optical system is large, a focusing operation is performed by keeping a hemispherical lens at a position close to the record surface of the optical disc and shifting another optical element in the direction of the optical axis when the wavelength of the laser beam from a light source varies. An optical arrangement defined after the focusing operation has been performed is different from a designed optical arrangement. Therefore, regarding the optical arrangement after the focusing operation, optical performance might deteriorate.

For this reason, it is desirable that the longitudinal chromatic aberration of the objective optical system is suitably corrected. However, if the longitudinal chromatic aberration is corrected through the diffraction effect, the number of annular zones in the diffraction surface inevitably increases to achieve a high degree of correction effect by the diffraction surface. In this case, the width of each annular zone may decrease to a level corresponding to several multiples of the wavelength of the laser beam, which may decrease the amount of transmitted light. Incidentally, the longitudinal chromatic aberration is not a chromatic aberration obtained through a paraxial calculation (i.e., paraxial chromatic aberration), but is a difference between an optimum position of an image surface defined at a design wavelength and an optimum position of an image surface defined when the actual wavelength is slightly different from the design wavelength.

### SUMMARY OF THE INVENTION

The present invention is advantageous in that it provides an optical element and an objective optical system to be mounted on an optical information recording/reproducing device, capable of suitably suppressing the longitudinal chromatic aberration caused when a wavelength of a laser beam being used slightly shifts from a design wavelength while suppressing loss of light amount to the minimum level during information recording or information reproducing for an optical disc having a still higher recording density.

According to an aspect of the invention, there is provided an optical element for an objective optical system mounted on an optical information recording/reproducing device for recording information to and/or reproducing information from an optical disc by letting a laser beam from a light source be incident on a record surface of the optical disc. The objective optical system is configured to satisfy conditions:

λ<500 (1);

NA≧0.7 (2); and

f≦1.0 (3),

where λ (unit: nm) denotes a design wavelength of the laser beam emitted by the light source, NA denotes a numerical aperture on an image side, and f (unit: mm) denotes a focal length. At least one of surfaces of the optical element including a diffraction structure defined by an optical path difference function φ(h):

φ(h)=(P₂h²+P₄h⁴+P₆h⁶+P₈h⁸+P₁₀h¹⁰+P₁₂h¹²)mλ

where P₂, P₄, P₆ . . . denote coefficients of 2^{nd} order, 4^{th} order, 6^{th} order . . . , respectively, h denotes a height from an optical axis of the optical element, and m denotes a diffraction order at which diffraction efficiency for the laser beam is maximized. The diffraction structure satisfies conditions:

P₂<0 (4);

P₂×P₄<−100 (5); and

−60<P₂/P₄<0 (6).

With this configuration, for information recording or information reproducing for an optical disc having a still higher recording density, it is possible to suitably suppress the longitudinal chromatic aberration due to minute wavelength shifts while suppressing loss of light to a minimum level. In general, the required light amount of a beam spot for accurate information recording or information reproducing for the optical disc becomes larger as the recording density of the optical disc becomes higher. Therefore, the optical element described above is suitably used for an optical information recording/reproducing device for information recording/reproducing for the optical disc having the still higher recording density.

According to another aspect of the invention, there is provided an objective optical system for an optical information recording/reproducing device for recording information to and/or reproducing information from an optical disc by letting a laser beam from a light source be incident on a record surface of the optical disc. The objective optical system includes an optical element, and a hemispheric lens which is located closely with respect to the optical disc and which is arranged such that a convex surface of the hemispheric lens faces a side of the optical element. The objective optical system is configured to satisfy conditions:

λ<500 (1);

NA≧0.7 (2); and

f≦1.0 (3),

where λ (unit: nm) denotes a design wavelength of the laser beam emitted by the light source, NA denotes a numerical aperture on an image side, and f (unit: mm) denotes a focal length. At least one of surfaces of the optical element including a diffraction structure defined by an optical path difference function φ(h):

φ(h)=(P₂h²+P₄h⁴+P₆h⁶+P₈h⁸+P₁₀h¹⁰+P₁₂h¹²)mλ

where P₂, P₄, P₆ . . . denote coefficients of 2^{nd} order, 4^{th} order, 6^{th} order . . . , respectively, h denotes a height from an optical axis of the optical element, and m denotes a diffraction order at which diffraction efficiency for the laser beam is maximized. The diffraction structure satisfying conditions:

P₂<0 (4);

P₂×P₄<−100 (5); and

−60<P₂/P₄<0 (6).

In this configuration, information recording or information reproducing for the optical disc being performed with an evanescent wave emerging from the hemispheric lens when the laser beam passed through the optical element is incident on the hemispheric lens.

With this configuration, for information recording or information reproducing for an optical disc having a still higher recording density, it is possible to suitably suppress the longitudinal chromatic aberration due to minute wavelength shifts while suppressing loss of light to a minimum level. In general, the required light amount of a beam spot for accurate information recording or information reproducing for the optical disc becomes larger as the recording density of the optical disc becomes higher. Therefore, the objective optical system described above is suitably used for an optical information recording/reproducing device for information recording/reproducing for the optical disc having the still higher recording density.

With regard to the above described optical element or the objective optical system, when SAM5 (unit: mm) denotes spherical aberration caused in the objective optical system for a marginal ray when a wavelength of the laser beam shifts by 5 nm from the design wavelength, and CA5 (unit: mm) denotes paraxial chromatic aberration of the objective optical system defined when the wavelength of the laser beam shifts by 5 nm from the design wavelength, the optical element may satisfy conditions:

SAM5>0 (7);

CA5<0 (8); and

0<SAM5−CA5<0.001 (9).

In at least one aspect, the diffraction structure may include a plurality of annular zones, and the diffraction structure is configured to satisfy a condition:

L10/L05>0.5 (10),

where L10 denotes a width of an annular zone through which a light ray having an entrance pupil coordinate of 1.0 passes, and L05 denotes a width of an annular zone through which a light ray having an entrance pupil coordinate of 0.5 passes.

In at least one aspect, the objective optical system may satisfy a condition:

NA≧1.0 (11).

According to another aspect of the invention, there is provided an optical information recording/reproducing device for recording information to and/or reproducing information from an optical disc. The optical information recording/reproducing device includes a light source which emits a laser beam, and one of the above described optical element.

With this configuration, for information recording or information reproducing for an optical disc having a still higher recording density, it is possible to suitably suppress the longitudinal chromatic aberration due to minute wavelength shifts while suppressing loss of light to a minimum level.

According to another aspect of the invention, there is provided an optical information recording/reproducing device for recording information to and/or reproducing information from an optical disc. The optical information recording/reproducing device includes a light source which emits a laser beam, and one of the above described objective optical system.

With this configuration, for information recording or information reproducing for an optical disc having a still higher recording density, it is possible to suitably suppress the longitudinal chromatic aberration due to minute wavelength shifts while suppressing loss of light to a minimum level.

### BRIEF DESCRIPTION OF THE ACCOMPANYING DRAWINGS

FIG. 1 is an optical block diagram illustrating a general configuration of an optical system for an optical information recording/reproducing device according to an embodiment.

FIG. 2A is a graph illustrating the spherical aberration caused in the objective optical system according to an example of the embodiment.

FIG. 2B is a graph illustrating the spherical aberration caused in an objective optical system according to a comparative example.

FIG. 3 is a graph illustrating the longitudinal chromatic aberration for each of the above described example of the embodiment and the comparative example.

FIG. 4 shows a diffraction structure formed on an objective lens for each of the example of the embodiment and the comparative example.

FIG. 5 illustrates an enlarged view of a part of the graph shown in FIG. 4.

FIG. 6 is a conceptual illustration of a diffraction lens structure formed on a lens surface of an objective lens.

### DETAILED DESCRIPTION OF THE EMBODIMENTS

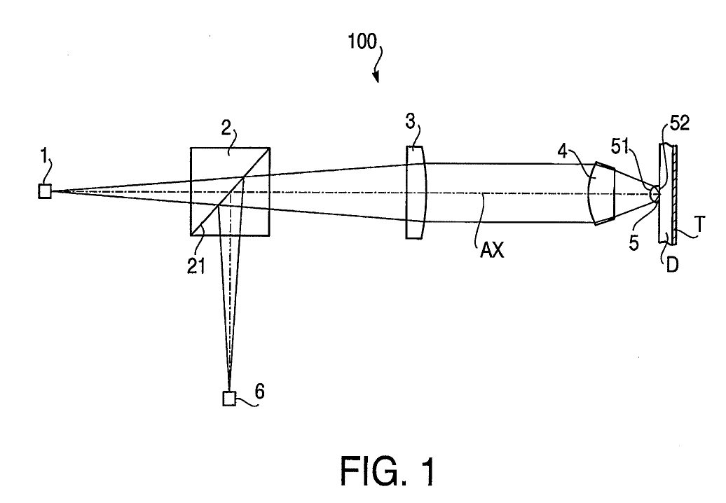

Hereinafter, an optical system for an optical information recording/reproducing device according to an embodiment is described with reference to the accompanying drawings. FIG. 1 is an optical block diagram illustrating a general configuration of an optical system 100 for an optical information recording/reproducing device. The optical system 100 is used for an optical information recording/reproducing device capable of executing information recording or information reproducing for a next-generation optical disc having a still higher recording density than an optical disc, such as HD DVD or BD having a relatively high recording density.

As shown in FIG. 1, the optical system 100 includes a light source 1, a beam splitter 2, a collimator lens 3, an objective lens 4, an SIL (Solid Immersion Lens) 5, and a photoreceptor 6. It should be noted that the objective optical system 100 may be provided with an aperture stop having a predetermined diameter so that a required NA (numerical aperture) can be secured for information recording or information reproducing for an optical disc being used.

More specifically, the light source 1, the beam splitter 2, the collimator lens 3, the objective lens 4 and the SIL 5 are aligned on a reference axis AX. The photoreceptor 6 is also aligned on the reference axis AX in a state where an optical path is developed.

The SIL 5 has a form of a hemisphere, and has a hemispheric convex surface 51 and a flat surface 52. The SIL 5 is positioned such that the convex surface 51 faces the objective lens 4.

Incidentally, an optical disc D is placed on a turn table T in the optical information recording/reproducing device and is rotated when the information recording or information reproducing is performed. As shown in FIG. 1, the objective optical system 100 is located on the opposite side of the turn table T with respect to the optical disc D.

The information recording or the information reproducing for the optical disc D is executed as follows. When the optical disc D is placed on the turn table T, the SIL 5 is positioned closely to a surface of the optical disc D by a driving mechanism (not shown). Since a distance between the surface of the optical disc D and an internal record layer of the optical disc D is extremely small, it can be expressed that the SIL 5 is positioned closely to the record layer of the optical disc D.

In the above described arrangement, the laser beam emitted by the light source 1 passes through the beam splitter 2, and then enters the collimator lens 3. The laser beam collimated by the collimator lens 3 is then incident on the objective lens 4. The laser beam emerging from the objective lens 4 enters the convex surface 51 of the SIL 5 as a converging beam.

As described above the SIL lens 5 is positioned closely to the record layer of the optical disc D. The SIL 5 is positioned to have such a positional relationship with the objective lens 4 that the laser beam which entered the SIL 5 is incident on the flat surface 52 at an incident angle larger than or equal to a critical angle. Therefore, the laser beam is reflected totally by the flat surface 52.

When the laser beam is totally reflected, an evanescent wave emerges from the flat surface 52. The evanescent wave enters the record layer of the optical disc D. The light reflected from the record layer returns along the same optical path along which the laser beam from the light source 1 proceeds, and is reflected from an optical branch surface 21 of the beam splitter 2. The returning light reflected from the optical branch surface 21 is received by the photoreceptor 6.

As described in detail below, the objective optical system 100 is configured to suitably suppress the longitudinal chromatic aberration while preventing loss of light amount.

In the following, it is assumed that the objective optical system 100 is mounted on the optical information recording/reproducing device for information recording or information reproducing for an optical disc having a still higher recording density than existing optical discs including CD and DVD. In this case, the design wavelength λ of the laser beam emitted by the light source 1 and the NA on the image side of the objective optical system 100 are set to satisfy the following conditions (1) and (2).

λ<500 (1);

NA≧0.7 (2)

By satisfying the conditions (1) and (2), it is possible to form a suitable small beam spot for information recording or information reproducing on the record surface of the optical disc having the still higher recording density.

The objective optical system 100 may be configured to further satisfy a condition:

NA≧1.0 (11).

The objective optical system 100 is configured that a focal length f (unit: mm) thereof satisfies a condition:

f≦1.0 (3).

By satisfying the condition (3), it is possible downsize the objective optical system 100 and to suppress the paraxial chromatic aberration to a low level. It should be noted that the smallness of the paraxial chromatic aberration has a great effect on correction of the longitudinal spherical aberration.

In order to form a suitable beam spot for information recording or information reproducing on the record surface of the optical disc D while effectively suppressing the aberrations, at least one of surfaces of the objective lens 4 is configured to be an aspherical surface.

A shape of an aspherical surface is expressed by a following equation:

$$X ( h ) = \frac{{ch}^{2}}{1 + \sqrt{1 - ( 1 + K ) {c}^{2} {h}^{2}}} + {\sum }_{i = 2} {A}_{2 i} {h}^{2 i}$$

where, X(h) represents a SAG amount which is a distance between a point on the aspherical surface at a height of h from the optical axis and a plane tangential to the aspherical surface at the optical axis, symbol c represents curvature (1/r) on the optical axis, K is a conical coefficient, and A₂ᵢ (i: integer≧1) represents an aspherical coefficient of an even order larger than or equal to the fourth order.

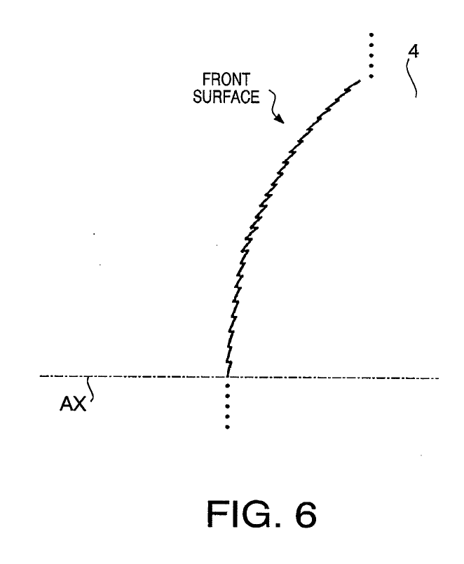

Further, the objective lens 4 is provided with a diffraction structure on at least one of surfaces of the objective lens 4. The diffraction structure is provided with a plurality of refractive surface zones (annular zones) concentrically formed about the optical axis (corresponding to the reference axis AX when the tracking operation is not executed). The refractive surface zones are divided by minute steps, each of which extends substantially in parallel with the direction of the optical axis. Each step is configured to give an optical path length difference between a beam passing through the inside of the step and a beam passing through the outside of the step. Therefore, such a diffraction structure may be expressed as an annular structure or a phase shift structure. If the diffraction structure is expressed as a diffraction structure having an n-th blazed wavelength, the diffraction structure can be regarded as being designed such that an optical path length difference given between the inside of the step and the outside of the step is equal to an n-fold (n: integer) of a particular wavelength. The diffraction order of the diffracted light having the maximum diffraction efficiency defined when a laser beam having a particular wavelength β passes through the diffraction structure is an integer m which is closest to a value obtained by dividing the optical path length difference by the wavelength β. FIG. 6 is a conceptual illustration of the diffraction structure formed on a front (light source side) surface of the objective lens 4.

The diffraction structure is configured to give a predetermined optical path length difference to an incident laser beam. Therefore, the diffraction structure can be expressed by an optical path difference function φ(h) indicted below.

An optical path difference function represents a function as a diffraction lens in a form of an additional optical path length at a height h from the optical axis. More specifically, an optical path difference function φ(h) can be expressed by an equation:

φ(h)=(P₂h²+P₄h⁴+P₆h⁶+P₈h⁸+P₁₀h¹⁰+P₁₂h¹²)mλ

where P₂, P₄, P₆ . . . represent coefficients of the 2^{nd} order, 4^{th} order, 6^{th} order, respectively, h represents a height from the optical axis, m represents a diffraction order at which the diffraction efficiency is maximized, and λ represents a design wavelength of an incident laser beam.

The diffraction structure is configured to satisfy the following conditions (4), (5) and (6).

P₂<0 (4);

P₂×P₄<−100 (5); and

−60<P₂/P₄<0 (6).

By satisfying the conditions (4), (5) and (6), it is possible to maintain the width of each annular zone through which a marginal light ray passes at a value approximately equal to a ten-fold of the design wavelength while sufficiently suppressing the longitudinal chromatic aberration to the extent that accurate information recording or information reproducing on the record surface of the optical disc D is not badly affected. By keeping the width of each annular zone at a value approximately equal to a ten-fold of the design wavelength, the laser beam entering the peripheral part of the objective lens 4 is able to pass through the diffraction structure without causing loss of light amount. That is, it is possible to cause the increased amount of light to enter the record surface of the optical disc D while suitably suppressing the longitudinal chromatic aberration.

More specifically, the diffraction structure is configured to control values of the coefficients P₂ and P₄ to satisfy the conditions (4), (5) and (6) by setting the coefficient P₂ to have a negative value and setting the coefficient P₄ to have a positive value and to have an appropriate relationship with the coefficient P₂. With this configuration, the diffraction structure intentionally produces the spherical aberration which changes depending on change of the wavelength of the laser beam while excessively correcting the paraxial chromatic aberration (i.e., bringing a condition of the paraxial chromatic aberration to an overcorrected condition).

By controlling values of the coefficients P₂ and P₄ to satisfy the conditions (5) and (6), it is possible to set the spherical aberration defined at an entrance pupil coordinate of 0.7 when the wavelength varies by a minute amount (e.g., by approximately ±13 nm) from the design wavelength to have an value approximately equal to the amount of the spherical aberration defined at the same pupil coordinate of the laser beam of the design wavelength. The term overcorrected condition means that the paraxial chromatic aberration is corrected to the extent that the paraxial chromatic aberration becomes negative from the condition where the paraxial chromatic aberration at a predetermined wavelength is positive, or that the paraxial chromatic aberration is corrected to the extent that the paraxial chromatic aberration becomes positive from the condition where the paraxial chromatic aberration at a predetermined wavelength is negative.

By configuring the objective optical system 100 as described above, it is possible to bring the optimum position of the image surface defined for the laser beam of which wavelength shifts in a minute amount, to an optimum position of an image surface of the laser beam having the design wavelength (i.e., a position in the vicinity of the record surface of the optical disc D). In other words, by configuring the objective lens 4 as described above, the objective optical system 100 is able to correct the longitudinal chromatic aberration while suppressing loss of light.

Further, when SAM5 (unit: mm) denotes the spherical aberration caused in the objective optical system 100 for a marginal ray when the wavelength of the laser beam shifts by 5 nm from the design wavelength, and CA5 (unit: mm) denotes the paraxial chromatic aberration of the objective optical system 100 defined when the wavelength of the laser beam shifts by 5 nm from the design wavelength, the objective lens 4 is configured to satisfy the following conditions (7), (8) and (9).

SAM5>0 (7);

CA5<0 (8); and

0<SAM5−CA5<0.001 (9)

The conditions (7), (8) and (9) relate to the longitudinal chromatic aberration. By satisfying the conditions (7), (8) and (9), the optimum position of the image surface defined when the wavelength shift occurs can be brought to the optimum position of the image surface defined at the design wavelength, and therefore the longitudinal chromatic aberration can be brought to a suitable condition. In addition, it is possible to suitably suppress the spherical aberration caused when the wavelength shift occurs.

When L 10 denotes the width of an annular zone through which a light ray having the entrance pupil coordinate of 1.0 passes, and L05 denotes the width of an annular zone through which a light ray having the entrance pupil coordinate of 0.5 passes, the diffraction structure on the objective lens 4 is configured to satisfy a condition:

L10/L05>0.5 (10).

The condition (10) relates to the amount of transmitted light. By satisfying the condition (10), it is possible to secure an adequate amount of transmitted light at the peripheral portion of the objective lens 4. That is, it is possible to prevent the amount of transmitted light in the peripheral portion of the objective lens 4 from decreasing rapidly.

Hereafter, a concrete example of the objective optical system 100 including the objective lens 4 is explained.

### EXAMPLE

The following Table 1 shows concrete specifications of the objective optical system 100 according to an example. Table 2 shows a specific numerical configuration of the optical information recording/reproducing device provided with the objective optical system 100 shown in Table 1.

TABLE 1

| | |
|---|---|
| Wavelength λ (nm) | 408 |
| Focal Length f (mm) | 1.000 |
| NA | 2.000 |
| Magnification | 0.000 |
| SAM5 (mm) | 0.0003 |
| CA5 (mm) | −0.0005 |

TABLE 2

| Surface | | | | | |
|---|---|---|---|---|---|
| No. | r | d | n (408 nm) | n (413 nm) | |
| 0 | — | ∞ | 1.00000 | 1.00000 | Light Source |
| 1 | 4.442 | 2.000 | 1.52424 | 1.52351 | Objective |
| 2 | 165.169 | 2.637 | 1.00000 | 1.00000 | Lens |
| 3 | 0.500 | 0.710 | 2.37832 | 2.37028 | SIL |
| 4 | ∞ | — | | | |

As indicated by the “Magnification” in Table 1, the laser beam is incident upon the objective lens 4 as a collimated beam when the information recording or information reproducing is performed for the optical disc D.

In the Table 2, the surface #0 represents a light source, the surfaces #1 and #2 represent the front surface (light source side surface) and rear surface (optical disc side surface) of the objective lens 4, and the surfaces #3 and #4 represent the front and rear surfaces of the SIL 5. In Table 2 (and in the following similar Tables), “r” denotes the curvature radius (mm) of each optical surface, and “d” denotes the thickness of an optical component or the distance (mm) from each optical surface to the next optical surface during the information reproduction/recordation.

Each of the surfaces (surfaces #1 and #2) of the objective lens 4 is an aspherical surface. The following Table 3 shows the cone constants K and aspherical coefficients (A₂, A₄, . . . ) specifying the shape of each of the surfaces (surfaces #1 and #2) of the objective lens 4. In Table 3 (and in the following similar Tables), the notation “E” means the power of 10 with an exponent specified by the number to the right of E (e.g. “E-04” means “×10⁻⁴”).

TABLE 3

| Surface | | | | | | |
|---|---|---|---|---|---|---|
| No. | K | A4 | A6 | A8 | A10 | A12 |
| 1 | −0.6000 | 1.64110E−03 | 3.68840E−05 | 1.07150E−06 | 5.21390E−08 | 1.22660E−08 |
| 2 | 0.0000 | −2.59240E−04 | 6.07550E−05 | −5.13730E−06 | 9.64710E−07 | −6.94470E−08 |

In this example, the diffraction structure is formed on the front surface (surface #1) of the objective lens 4. Table 4 shows the coefficients P₂, P₄ . . . of the optical path difference function defining the diffraction structure. In this example, the diffraction order m at which the diffraction efficiency for the laser beam is maximizes is 1.

TABLE 4

| Surface No. | P2 | P4 | P6 |
|---|---|---|---|
| 1 | −7.50000E+01 | 1.50000E+00 | 0.00000E+00 |
| Surface No. | P8 | P10 | P12 |
| 1 | 0.00000E+00 | 0.00000E+00 | 0.00000E+00 |

The diffraction structure defined by Table 4 included totally 277 annular zones ranging from 0-th annular zone to 276-th annular zone. The concrete configuration of the diffraction structure is shown in the following Tables 5-10. In Tables 5-10, the number is assigned to each annular zone in ascending order from the position of the optical axis.

TABLE 5

| Annular | Start Position | End Position | Annular Zone |
|---|---|---|---|
| Zone No. | (mm) | (mm) | Width (μm) |
| 0 | 0.0000 | 0.0817 | 81.7 |
| 1 | 0.0817 | 0.1414 | 59.8 |
| 2 | 0.1414 | 0.1826 | 41.2 |
| 3 | 0.1826 | 0.2161 | 33.5 |
| 4 | 0.2161 | 0.2451 | 29.0 |
| 5 | 0.2451 | 0.2710 | 25.9 |
| 6 | 0.2710 | 0.2946 | 23.6 |
| 7 | 0.2946 | 0.3165 | 21.9 |
| 8 | 0.3165 | 0.3370 | 20.5 |
| 9 | 0.3370 | 0.3564 | 19.3 |
| 10 | 0.3564 | 0.3747 | 18.3 |
| 11 | 0.3747 | 0.3922 | 17.5 |
| 12 | 0.3922 | 0.4089 | 16.8 |
| 13 | 0.4089 | 0.4250 | 16.1 |
| 14 | 0.4250 | 0.4406 | 15.5 |
| 15 | 0.4406 | 0.4556 | 15.0 |
| 16 | 0.4556 | 0.4701 | 14.5 |
| 17 | 0.4701 | 0.4842 | 14.1 |
| 18 | 0.4842 | 0.4979 | 13.7 |
| 19 | 0.4979 | 0.5112 | 13.3 |
| 20 | 0.5112 | 0.5243 | 13.0 |
| 21 | 0.5243 | 0.5370 | 12.7 |
| 22 | 0.5370 | 0.5494 | 12.4 |
| 23 | 0.5494 | 0.5615 | 12.2 |
| 24 | 0.5615 | 0.5734 | 11.9 |
| 25 | 0.5734 | 0.5851 | 11.7 |
| 26 | 0.5851 | 0.5965 | 11.4 |
| 27 | 0.5965 | 0.6078 | 11.2 |
| 28 | 0.6078 | 0.6188 | 11.0 |
| 29 | 0.6188 | 0.6297 | 10.8 |
| 30 | 0.6297 | 0.6403 | 10.7 |
| 31 | 0.6403 | 0.6508 | 10.5 |
| 32 | 0.6508 | 0.6612 | 10.3 |
| 33 | 0.6612 | 0.6714 | 10.2 |
| 34 | 0.6714 | 0.6814 | 10.0 |
| 35 | 0.6814 | 0.6913 | 9.9 |
| 36 | 0.6913 | 0.7011 | 9.8 |
| 37 | 0.7011 | 0.7107 | 9.6 |
| 38 | 0.7107 | 0.7202 | 9.5 |
| 39 | 0.7202 | 0.7296 | 9.4 |
| 40 | 0.7296 | 0.7389 | 9.3 |
| 41 | 0.7389 | 0.7481 | 9.2 |
| 42 | 0.7481 | 0.7571 | 9.1 |
| 43 | 0.7571 | 0.7661 | 9.0 |
| 44 | 0.7661 | 0.7749 | 8.9 |
| 45 | 0.7749 | 0.7837 | 8.8 |
| 46 | 0.7837 | 0.7924 | 8.7 |
| 47 | 0.7924 | 0.8010 | 8.6 |
| 48 | 0.8010 | 0.8095 | 8.5 |
| 49 | 0.8095 | 0.8179 | 8.4 |

TABLE 6

| Annular | Start Position | End Position | Annular Zone |
|---|---|---|---|
| Zone No. | (mm) | (mm) | Width (μm) |
| 50 | 0.8179 | 0.8262 | 8.3 |
| 51 | 0.8262 | 0.8345 | 8.3 |
| 52 | 0.8345 | 0.8427 | 8.2 |
| 53 | 0.8427 | 0.8508 | 8.1 |
| 54 | 0.8508 | 0.8588 | 8.0 |
| 55 | 0.8588 | 0.8668 | 8.0 |
| 56 | 0.8668 | 0.8747 | 7.9 |
| 57 | 0.8747 | 0.8825 | 7.8 |
| 58 | 0.8825 | 0.8903 | 7.8 |
| 59 | 0.8903 | 0.8980 | 7.7 |
| 60 | 0.8980 | 0.9056 | 7.6 |
| 61 | 0.9056 | 0.9132 | 7.6 |
| 62 | 0.9132 | 0.9207 | 7.5 |
| 63 | 0.9207 | 0.9282 | 7.5 |
| 64 | 0.9282 | 0.9356 | 7.4 |
| 65 | 0.9356 | 0.9429 | 7.4 |
| 66 | 0.9429 | 0.9502 | 7.3 |
| 67 | 0.9502 | 0.9575 | 7.3 |
| 68 | 0.9575 | 0.9647 | 7.2 |
| 69 | 0.9647 | 0.9719 | 7.2 |
| 70 | 0.9719 | 0.9790 | 7.1 |
| 71 | 0.9790 | 0.9860 | 7.1 |
| 72 | 0.9860 | 0.9930 | 7.0 |
| 73 | 0.9930 | 1.0000 | 7.0 |
| 74 | 1.0000 | 1.0069 | 6.9 |
| 75 | 1.0069 | 1.0138 | 6.9 |
| 76 | 1.0138 | 1.0206 | 6.8 |
| 77 | 1.0206 | 1.0274 | 6.8 |
| 78 | 1.0274 | 1.0342 | 6.8 |
| 79 | 1.0342 | 1.0409 | 6.7 |
| 80 | 1.0409 | 1.0476 | 6.7 |
| 81 | 1.0476 | 1.0542 | 6.6 |
| 82 | 1.0542 | 1.0608 | 6.6 |
| 83 | 1.0608 | 1.0674 | 6.6 |
| 84 | 1.0674 | 1.0739 | 6.5 |
| 85 | 1.0739 | 1.0804 | 6.5 |
| 86 | 1.0804 | 1.0868 | 6.5 |
| 87 | 1.0868 | 1.0933 | 6.4 |
| 88 | 1.0933 | 1.0997 | 6.4 |
| 89 | 1.0997 | 1.1060 | 6.4 |
| 90 | 1.1060 | 1.1123 | 6.3 |
| 91 | 1.1123 | 1.1186 | 6.3 |
| 92 | 1.1186 | 1.1249 | 6.3 |
| 93 | 1.1249 | 1.1311 | 6.2 |
| 94 | 1.1311 | 1.1373 | 6.2 |
| 95 | 1.1373 | 1.1435 | 6.2 |
| 96 | 1.1435 | 1.1496 | 6.1 |
| 97 | 1.1496 | 1.1557 | 6.1 |
| 98 | 1.1557 | 1.1618 | 6.1 |
| 99 | 1.1618 | 1.1678 | 6.1 |

TABLE 7

| Annular | Start Position | End Position | Annular Zone |
|---|---|---|---|
| Zone No. | (mm) | (mm) | Width (μm) |
| 100 | 1.1678 | 1.1739 | 6.0 |
| 101 | 1.1739 | 1.1799 | 6.0 |
| 102 | 1.1799 | 1.1858 | 6.0 |
| 103 | 1.1858 | 1.1918 | 5.9 |
| 104 | 1.1918 | 1.1977 | 5.9 |
| 105 | 1.1977 | 1.2036 | 5.9 |
| 106 | 1.2036 | 1.2095 | 5.9 |
| 107 | 1.2095 | 1.2153 | 5.8 |
| 108 | 1.2153 | 1.2211 | 5.8 |
| 109 | 1.2211 | 1.2269 | 5.8 |
| 110 | 1.2269 | 1.2327 | 5.8 |
| 111 | 1.2327 | 1.2384 | 5.7 |
| 112 | 1.2384 | 1.2442 | 5.7 |
| 113 | 1.2442 | 1.2499 | 5.7 |
| 114 | 1.2499 | 1.2555 | 5.7 |
| 115 | 1.2555 | 1.2612 | 5.7 |
| 116 | 1.2612 | 1.2668 | 5.6 |
| 117 | 1.2668 | 1.2724 | 5.6 |
| 118 | 1.2724 | 1.2780 | 5.6 |
| 119 | 1.2780 | 1.2836 | 5.6 |
| 120 | 1.2836 | 1.2891 | 5.6 |
| 121 | 1.2891 | 1.2947 | 5.5 |
| 122 | 1.2947 | 1.3002 | 5.5 |
| 123 | 1.3002 | 1.3057 | 5.5 |
| 124 | 1.3057 | 1.3111 | 5.5 |
| 125 | 1.3111 | 1.3166 | 5.5 |
| 126 | 1.3166 | 1.3220 | 5.4 |
| 127 | 1.3220 | 1.3274 | 5.4 |
| 128 | 1.3274 | 1.3328 | 5.4 |
| 129 | 1.3328 | 1.3382 | 5.4 |
| 130 | 1.3382 | 1.3436 | 5.4 |
| 131 | 1.3436 | 1.3489 | 5.3 |
| 132 | 1.3489 | 1.3542 | 5.3 |
| 133 | 1.3542 | 1.3595 | 5.3 |
| 134 | 1.3595 | 1.3648 | 5.3 |
| 135 | 1.3648 | 1.3701 | 5.3 |
| 136 | 1.3701 | 1.3753 | 5.3 |
| 137 | 1.3753 | 1.3806 | 5.2 |
| 138 | 1.3806 | 1.3858 | 5.2 |
| 139 | 1.3858 | 1.3910 | 5.2 |
| 140 | 1.3910 | 1.3962 | 5.2 |
| 141 | 1.3962 | 1.4014 | 5.2 |
| 142 | 1.4014 | 1.4065 | 5.2 |
| 143 | 1.4065 | 1.4116 | 5.1 |
| 144 | 1.4116 | 1.4168 | 5.1 |
| 145 | 1.4168 | 1.4219 | 5.1 |
| 146 | 1.4219 | 1.4270 | 5.1 |
| 147 | 1.4270 | 1.4321 | 5.1 |
| 148 | 1.4321 | 1.4371 | 5.1 |
| 149 | 1.4371 | 1.4422 | 5.1 |

TABLE 8

| Annular | Start Position | End Position | Annular Zone |
|---|---|---|---|
| Zone No. | (mm) | (mm) | Width (μm) |
| 150 | 1.4422 | 1.4472 | 5.0 |
| 151 | 1.4472 | 1.4522 | 5.0 |
| 152 | 1.4522 | 1.4572 | 5.0 |
| 153 | 1.4572 | 1.4622 | 5.0 |
| 154 | 1.4622 | 1.4672 | 5.0 |
| 155 | 1.4672 | 1.4722 | 5.0 |
| 156 | 1.4722 | 1.4771 | 5.0 |
| 157 | 1.4771 | 1.4821 | 4.9 |
| 158 | 1.4821 | 1.4870 | 4.9 |
| 159 | 1.4870 | 1.4919 | 4.9 |
| 160 | 1.4919 | 1.4968 | 4.9 |
| 161 | 1.4968 | 1.5017 | 4.9 |
| 162 | 1.5017 | 1.5066 | 4.9 |
| 163 | 1.5066 | 1.5114 | 4.9 |
| 164 | 1.5114 | 1.5163 | 4.8 |
| 165 | 1.5163 | 1.5211 | 4.8 |
| 166 | 1.5211 | 1.5259 | 4.8 |
| 167 | 1.5259 | 1.5307 | 4.8 |
| 168 | 1.5307 | 1.5355 | 4.8 |
| 169 | 1.5355 | 1.5403 | 4.8 |
| 170 | 1.5403 | 1.5451 | 4.8 |
| 171 | 1.5451 | 1.5499 | 4.8 |
| 172 | 1.5499 | 1.5546 | 4.8 |
| 173 | 1.5546 | 1.5594 | 4.7 |
| 174 | 1.5594 | 1.5641 | 4.7 |
| 175 | 1.5641 | 1.5688 | 4.7 |
| 176 | 1.5688 | 1.5735 | 4.7 |
| 177 | 1.5735 | 1.5782 | 4.7 |
| 178 | 1.5782 | 1.5829 | 4.7 |
| 179 | 1.5829 | 1.5876 | 4.7 |
| 180 | 1.5876 | 1.5922 | 4.7 |
| 181 | 1.5922 | 1.5969 | 4.7 |
| 182 | 1.5969 | 1.6015 | 4.6 |
| 183 | 1.6015 | 1.6062 | 4.6 |
| 184 | 1.6062 | 1.6108 | 4.6 |
| 185 | 1.6108 | 1.6154 | 4.6 |
| 186 | 1.6154 | 1.6200 | 4.6 |
| 187 | 1.6200 | 1.6246 | 4.6 |
| 188 | 1.6246 | 1.6292 | 4.6 |
| 189 | 1.6292 | 1.6338 | 4.6 |
| 190 | 1.6338 | 1.6383 | 4.6 |
| 191 | 1.6383 | 1.6429 | 4.6 |
| 192 | 1.6429 | 1.6474 | 4.5 |
| 193 | 1.6474 | 1.6520 | 4.5 |
| 194 | 1.6520 | 1.6565 | 4.5 |
| 195 | 1.6565 | 1.6610 | 4.5 |
| 196 | 1.6610 | 1.6655 | 4.5 |
| 197 | 1.6655 | 1.6700 | 4.5 |
| 198 | 1.6700 | 1.6745 | 4.5 |
| 199 | 1.6745 | 1.6790 | 4.5 |

TABLE 9

| Annular | Start Position | End Position | Annular Zone |
|---|---|---|---|
| Zone No. | (mm) | (mm) | Width (μm) |
| 200 | 1.6790 | 1.6834 | 4.5 |
| 201 | 1.6834 | 1.6879 | 4.5 |
| 202 | 1.6879 | 1.6924 | 4.5 |
| 203 | 1.6924 | 1.6968 | 4.4 |
| 204 | 1.6968 | 1.7012 | 4.4 |
| 205 | 1.7012 | 1.7057 | 4.4 |
| 206 | 1.7057 | 1.7101 | 4.4 |
| 207 | 1.7101 | 1.7145 | 4.4 |
| 208 | 1.7145 | 1.7189 | 4.4 |
| 209 | 1.7189 | 1.7233 | 4.4 |
| 210 | 1.7233 | 1.7277 | 4.4 |
| 211 | 1.7277 | 1.7320 | 4.4 |
| 212 | 1.7320 | 1.7364 | 4.4 |
| 213 | 1.7364 | 1.7408 | 4.4 |
| 214 | 1.7408 | 1.7451 | 4.4 |
| 215 | 1.7451 | 1.7495 | 4.3 |
| 216 | 1.7495 | 1.7538 | 4.3 |
| 217 | 1.7538 | 1.7582 | 4.3 |
| 218 | 1.7582 | 1.7625 | 4.3 |
| 219 | 1.7625 | 1.7668 | 4.3 |
| 220 | 1.7668 | 1.7711 | 4.3 |
| 221 | 1.7711 | 1.7754 | 4.3 |
| 222 | 1.7754 | 1.7797 | 4.3 |
| 223 | 1.7797 | 1.7840 | 4.3 |
| 224 | 1.7840 | 1.7883 | 4.3 |
| 225 | 1.7883 | 1.7925 | 4.3 |
| 226 | 1.7925 | 1.7968 | 4.3 |
| 227 | 1.7968 | 1.8010 | 4.3 |
| 228 | 1.8010 | 1.8053 | 4.3 |
| 229 | 1.8053 | 1.8095 | 4.2 |
| 230 | 1.8095 | 1.8138 | 4.2 |
| 231 | 1.8138 | 1.8180 | 4.2 |
| 232 | 1.8180 | 1.8222 | 4.2 |
| 233 | 1.8222 | 1.8264 | 4.2 |
| 234 | 1.8264 | 1.8307 | 4.2 |
| 235 | 1.8307 | 1.8349 | 4.2 |
| 236 | 1.8349 | 1.8390 | 4.2 |
| 237 | 1.8390 | 1.8432 | 4.2 |
| 238 | 1.8432 | 1.8474 | 4.2 |
| 239 | 1.8474 | 1.8516 | 4.2 |
| 240 | 1.8516 | 1.8558 | 4.2 |
| 241 | 1.8558 | 1.8599 | 4.2 |
| 242 | 1.8599 | 1.8641 | 4.2 |
| 243 | 1.8641 | 1.8682 | 4.2 |
| 244 | 1.8682 | 1.8724 | 4.1 |
| 245 | 1.8724 | 1.8765 | 4.1 |
| 246 | 1.8765 | 1.8807 | 4.1 |
| 247 | 1.8807 | 1.8848 | 4.1 |
| 248 | 1.8848 | 1.8889 | 4.1 |
| 249 | 1.8889 | 1.8930 | 4.1 |

TABLE 10

| Annular | Start Position | End Position | Annular Zone |
|---|---|---|---|
| Zone No. | (mm) | (mm) | Width (μm) |
| 250 | 1.8930 | 1.8971 | 4.1 |
| 251 | 1.8971 | 1.9012 | 4.1 |
| 252 | 1.9012 | 1.9053 | 4.1 |
| 253 | 1.9053 | 1.9094 | 4.1 |
| 254 | 1.9094 | 1.9135 | 4.1 |
| 255 | 1.9135 | 1.9176 | 4.1 |
| 256 | 1.9176 | 1.9216 | 4.1 |
| 257 | 1.9216 | 1.9257 | 4.1 |
| 258 | 1.9257 | 1.9298 | 4.1 |
| 259 | 1.9298 | 1.9338 | 4.1 |
| 260 | 1.9338 | 1.9379 | 4.1 |
| 261 | 1.9379 | 1.9419 | 4.0 |
| 262 | 1.9419 | 1.9460 | 4.0 |
| 263 | 1.9460 | 1.9500 | 4.0 |
| 264 | 1.9500 | 1.9540 | 4.0 |
| 265 | 1.9540 | 1.9581 | 4.0 |
| 266 | 1.9581 | 1.9621 | 4.0 |
| 267 | 1.9621 | 1.9661 | 4.0 |
| 268 | 1.9661 | 1.9701 | 4.0 |
| 269 | 1.9701 | 1.9741 | 4.0 |
| 270 | 1.9741 | 1.9781 | 4.0 |
| 271 | 1.9781 | 1.9821 | 4.0 |
| 272 | 1.9821 | 1.9861 | 4.0 |
| 273 | 1.9861 | 1.9901 | 4.0 |
| 274 | 1.9901 | 1.9940 | 4.0 |
| 275 | 1.9940 | 1.9980 | 4.0 |
| 276 | 1.9980 | 2.0020 | 4.0 |

As shown in Table 1, the objective optical system 100 according to the example satisfies the conditions (1), (2) and (3). As shown in Table 4, in this example, P₂ is −75, P₂×P₄ is −112.5 and P₂/P₄ is −50. Therefore, all of the conditions (4), (5) and (6) are satisfied. The annular zone through which the marginal ray passes is an annular zone located at an outermost position on the objective lens 4. As shown in Table 10, the outermost annular zone (annular zone #276) has the width of 4.0 μm which is approximately equal to a ten-hold of the design wavelength λ.

Further, in this example, SAM5 is 0.0003, CA5 is −0.0005 and SAM5-CA5 is 0.0008. Therefore, all of the conditions (7), (8) and (9) are satisfied.

Since in this example L10/L05 is 0.58, the condition (10) is satisfied.

### COMPARATIVE EXAMPLE

Hereafter, a comparative example to be compared with the objective optical system 10 according to the above described example is explained. An objective optical system according to the comparative example is configured to have an optimally corrected condition where the spherical aberration and the longitudinal chromatic aberration are suitably corrected by the diffraction structure. A concrete configuration of the objective optical system according to the comparative examples is shown in the following Tables 11-20.

The following Table 11 shows concrete specifications of the objective optical system according to the comparative example. Table 12 shows a specific numerical configuration of the optical information recording/reproducing device provided with the objective optical system shown in Table 11.

TABLE 11

| | |
|---|---|
| Wavelength λ (nm) | 408 |
| Focal Length f (mm) | 1.000 |
| NA | 2.000 |
| Magnification | 0.000 |
| SAM5 | −0.0001 |
| CA5 | 0.0000 |

TABLE 12

| Surface | | | | | |
|---|---|---|---|---|---|
| No. | r | d | n (408 nm) | n (413 nm) | |
| 0 | — | ∞ | 1.00000 | 1.00000 | Light Source |
| 1 | 4.037 | 2.000 | 1.52424 | 1.52351 | Objective |
| 2 | 197.904 | 2.640 | 1.00000 | 1.00000 | Lens |
| 3 | 0.500 | 0.710 | 2.37832 | 2.37028 | SIL |
| 4 | ∞ | — | | | |

The following Table 13 shows the cone constants K and aspherical coefficients (A₂, A₄, . . . ) specifying the shape of each of the surfaces (surfaces #1 and #2) of an objective lens forming the objective optical system according to the comparative example.

TABLE 13

| Surface | | | | | | |
|---|---|---|---|---|---|---|
| No. | K | A4 | A6 | A8 | A10 | A12 |
| 1 | −0.6000 | −3.03280E−04 | −6.56810E−05 | −2.16060E−05 | −3.57770E−06 | −3.41910E−07 |
| 2 | 0.0000 | 8.10270E−04 | −1.66910E−04 | 2.84110E−05 | −1.60200E−05 | 1.06560E−06 |

Table 14 shows the coefficients P₂, P₄ . . . of the optical path difference function defining the diffraction structure formed on a front (light source side) surface of the objective lens according to the comparative example. In this example, the diffraction order m at which the diffraction efficiency for the laser beam is maximizes is 1. The concrete configuration of the diffraction structure according to the comparative example is shown in the following Tables 15-20.

TABLE 14

| Surface No. | P2 | P4 | P6 |
|---|---|---|---|
| 1 | −6.00000E+01 | −1.50000E+00 | −6.00000E−02 |
| Surface No. | P8 | P10 | P12 |
| 1 | −2.50000E−02 | −3.80000E−03 | 0.00000E+00 |

TABLE 15

| Annular | Start Position | End Position | Annular Zone |
|---|---|---|---|
| Zone No. | (mm) | (mm) | Width (μm) |
| 0 | 0.0000 | 0.0913 | 91.3 |
| 1 | 0.0913 | 0.1581 | 66.8 |
| 2 | 0.1581 | 0.2040 | 46.0 |
| 3 | 0.2040 | 0.2413 | 37.3 |
| 4 | 0.2413 | 0.2736 | 32.3 |
| 5 | 0.2736 | 0.3024 | 28.8 |
| 6 | 0.3024 | 0.3287 | 26.3 |
| 7 | 0.3287 | 0.3530 | 24.3 |
| 8 | 0.3530 | 0.3757 | 22.7 |
| 9 | 0.3757 | 0.3971 | 21.4 |
| 10 | 0.3971 | 0.4174 | 20.3 |
| 11 | 0.4174 | 0.4367 | 19.3 |
| 12 | 0.4367 | 0.4552 | 18.5 |
| 13 | 0.4552 | 0.4730 | 17.8 |
| 14 | 0.4730 | 0.4901 | 17.1 |
| 15 | 0.4901 | 0.5066 | 16.5 |
| 16 | 0.5066 | 0.5226 | 16.0 |
| 17 | 0.5226 | 0.5381 | 15.5 |
| 18 | 0.5381 | 0.5531 | 15.0 |
| 19 | 0.5531 | 0.5678 | 14.6 |
| 20 | 0.5678 | 0.5820 | 14.3 |
| 21 | 0.5820 | 0.5959 | 13.9 |
| 22 | 0.5959 | 0.6095 | 13.6 |
| 23 | 0.6095 | 0.6228 | 13.3 |
| 24 | 0.6228 | 0.6357 | 13.0 |
| 25 | 0.6357 | 0.6485 | 12.7 |
| 26 | 0.6485 | 0.6609 | 12.5 |
| 27 | 0.6609 | 0.6731 | 12.2 |
| 28 | 0.6731 | 0.6851 | 12.0 |
| 29 | 0.6851 | 0.6969 | 11.8 |
| 30 | 0.6969 | 0.7084 | 11.6 |
| 31 | 0.7084 | 0.7198 | 11.4 |
| 32 | 0.7198 | 0.7310 | 11.2 |
| 33 | 0.7310 | 0.7420 | 11.0 |
| 34 | 0.7420 | 0.7528 | 10.8 |
| 35 | 0.7528 | 0.7635 | 10.7 |
| 36 | 0.7635 | 0.7740 | 10.5 |
| 37 | 0.7740 | 0.7844 | 10.4 |
| 38 | 0.7844 | 0.7946 | 10.2 |
| 39 | 0.7946 | 0.8047 | 10.1 |
| 40 | 0.8047 | 0.8146 | 9.9 |
| 41 | 0.8146 | 0.8244 | 9.8 |
| 42 | 0.8244 | 0.8341 | 9.7 |
| 43 | 0.8341 | 0.8437 | 9.6 |
| 44 | 0.8437 | 0.8532 | 9.5 |
| 45 | 0.8532 | 0.8625 | 9.3 |
| 46 | 0.8625 | 0.8718 | 9.2 |
| 47 | 0.8718 | 0.8809 | 9.1 |
| 48 | 0.8809 | 0.8899 | 9.0 |
| 49 | 0.8899 | 0.8989 | 8.9 |

TABLE 16

| Annular | Start Position | End Position | Annular Zone |
|---|---|---|---|
| Zone No. | (mm) | (mm) | Width (μm) |
| 50 | 0.8989 | 0.9077 | 8.8 |
| 51 | 0.9077 | 0.9164 | 8.7 |
| 52 | 0.9164 | 0.9251 | 8.7 |
| 53 | 0.9251 | 0.9337 | 8.6 |
| 54 | 0.9337 | 0.9421 | 8.5 |
| 55 | 0.9421 | 0.9505 | 8.4 |
| 56 | 0.9505 | 0.9589 | 8.3 |
| 57 | 0.9589 | 0.9671 | 8.2 |
| 58 | 0.9671 | 0.9753 | 8.2 |
| 59 | 0.9753 | 0.9833 | 8.1 |
| 60 | 0.9833 | 0.9914 | 8.0 |
| 61 | 0.9914 | 0.9993 | 7.9 |
| 62 | 0.9993 | 1.0072 | 7.9 |
| 63 | 1.0072 | 1.0150 | 7.8 |
| 64 | 1.0150 | 1.0227 | 7.7 |
| 65 | 1.0227 | 1.0304 | 7.7 |
| 66 | 1.0304 | 1.0380 | 7.6 |
| 67 | 1.0380 | 1.0455 | 7.5 |
| 68 | 1.0455 | 1.0530 | 7.5 |
| 69 | 1.0530 | 1.0604 | 7.4 |
| 70 | 1.0604 | 1.0678 | 7.4 |
| 71 | 1.0678 | 1.0751 | 7.3 |
| 72 | 1.0751 | 1.0824 | 7.3 |
| 73 | 1.0824 | 1.0895 | 7.2 |
| 74 | 1.0895 | 1.0967 | 7.1 |
| 75 | 1.0967 | 1.1038 | 7.1 |
| 76 | 1.1038 | 1.1108 | 7.0 |
| 77 | 1.1108 | 1.1178 | 7.0 |
| 78 | 1.1178 | 1.1247 | 6.9 |
| 79 | 1.1247 | 1.1316 | 6.9 |
| 80 | 1.1316 | 1.1385 | 6.8 |
| 81 | 1.1385 | 1.1452 | 6.8 |
| 82 | 1.1452 | 1.1520 | 6.7 |
| 83 | 1.1520 | 1.1587 | 6.7 |
| 84 | 1.1587 | 1.1653 | 6.7 |
| 85 | 1.1653 | 1.1719 | 6.6 |
| 86 | 1.1719 | 1.1785 | 6.6 |
| 87 | 1.1785 | 1.1850 | 6.5 |
| 88 | 1.1850 | 1.1915 | 6.5 |
| 89 | 1.1915 | 1.1979 | 6.4 |
| 90 | 1.1979 | 1.2043 | 6.4 |
| 91 | 1.2043 | 1.2107 | 6.4 |
| 92 | 1.2107 | 1.2170 | 6.3 |
| 93 | 1.2170 | 1.2233 | 6.3 |
| 94 | 1.2233 | 1.2295 | 6.2 |
| 95 | 1.2295 | 1.2357 | 6.2 |
| 96 | 1.2357 | 1.2419 | 6.2 |
| 97 | 1.2419 | 1.2480 | 6.1 |
| 98 | 1.2480 | 1.2541 | 6.1 |
| 99 | 1.2541 | 1.2602 | 6.1 |

TABLE 17

| Annular | Start Position | End Position | Annular Zone |
|---|---|---|---|
| Zone No. | (mm) | (mm) | Width (μm) |
| 100 | 1.2602 | 1.2662 | 6.0 |
| 101 | 1.2662 | 1.2722 | 6.0 |
| 102 | 1.2722 | 1.2781 | 5.9 |
| 103 | 1.2781 | 1.2840 | 5.9 |
| 104 | 1.2840 | 1.2899 | 5.9 |
| 105 | 1.2899 | 1.2958 | 5.8 |
| 106 | 1.2958 | 1.3016 | 5.8 |
| 107 | 1.3016 | 1.3073 | 5.8 |
| 108 | 1.3073 | 1.3131 | 5.8 |
| 109 | 1.3131 | 1.3188 | 5.7 |
| 110 | 1.3188 | 1.3245 | 5.7 |
| 111 | 1.3245 | 1.3302 | 5.7 |
| 112 | 1.3302 | 1.3358 | 5.6 |
| 113 | 1.3358 | 1.3414 | 5.6 |
| 114 | 1.3414 | 1.3470 | 5.6 |
| 115 | 1.3470 | 1.3525 | 5.5 |
| 116 | 1.3525 | 1.3580 | 5.5 |
| 117 | 1.3580 | 1.3635 | 5.5 |
| 118 | 1.3635 | 1.3689 | 5.5 |
| 119 | 1.3689 | 1.3744 | 5.4 |
| 120 | 1.3744 | 1.3798 | 5.4 |
| 121 | 1.3798 | 1.3851 | 5.4 |
| 122 | 1.3851 | 1.3905 | 5.3 |
| 123 | 1.3905 | 1.3958 | 5.3 |
| 124 | 1.3958 | 1.4011 | 5.3 |
| 125 | 1.4011 | 1.4064 | 5.3 |
| 126 | 1.4064 | 1.4116 | 5.2 |
| 127 | 1.4116 | 1.4168 | 5.2 |
| 128 | 1.4168 | 1.4220 | 5.2 |
| 129 | 1.4220 | 1.4272 | 5.2 |
| 130 | 1.4272 | 1.4323 | 5.1 |
| 131 | 1.4323 | 1.4374 | 5.1 |
| 132 | 1.4374 | 1.4425 | 5.1 |
| 133 | 1.4425 | 1.4476 | 5.1 |
| 134 | 1.4476 | 1.4526 | 5.0 |
| 135 | 1.4526 | 1.4576 | 5.0 |
| 136 | 1.4576 | 1.4626 | 5.0 |
| 137 | 1.4626 | 1.4676 | 5.0 |
| 138 | 1.4676 | 1.4725 | 4.9 |
| 139 | 1.4725 | 1.4775 | 4.9 |
| 140 | 1.4775 | 1.4824 | 4.9 |
| 141 | 1.4824 | 1.4872 | 4.9 |
| 142 | 1.4872 | 1.4921 | 4.9 |
| 143 | 1.4921 | 1.4969 | 4.8 |
| 144 | 1.4969 | 1.5017 | 4.8 |
| 145 | 1.5017 | 1.5065 | 4.8 |
| 146 | 1.5065 | 1.5113 | 4.8 |
| 147 | 1.5113 | 1.5161 | 4.7 |
| 148 | 1.5161 | 1.5208 | 4.7 |
| 149 | 1.5208 | 1.5255 | 4.7 |

TABLE 18

| Annular | Start Position | End Position | Annular Zone |
|---|---|---|---|
| Zone No. | (mm) | (mm) | Width (μm) |
| 150 | 1.5255 | 1.5302 | 4.7 |
| 151 | 1.5302 | 1.5348 | 4.7 |
| 152 | 1.5348 | 1.5395 | 4.6 |
| 153 | 1.5395 | 1.5441 | 4.6 |
| 154 | 1.5441 | 1.5487 | 4.6 |
| 155 | 1.5487 | 1.5533 | 4.6 |
| 156 | 1.5533 | 1.5579 | 4.6 |
| 157 | 1.5579 | 1.5624 | 4.5 |
| 158 | 1.5624 | 1.5670 | 4.5 |
| 159 | 1.5670 | 1.5715 | 4.5 |
| 160 | 1.5715 | 1.5760 | 4.5 |
| 161 | 1.5760 | 1.5804 | 4.5 |
| 162 | 1.5804 | 1.5849 | 4.5 |
| 163 | 1.5849 | 1.5893 | 4.4 |
| 164 | 1.5893 | 1.5937 | 4.4 |
| 165 | 1.5937 | 1.5981 | 4.4 |
| 166 | 1.5981 | 1.6025 | 4.4 |
| 167 | 1.6025 | 1.6069 | 4.4 |
| 168 | 1.6069 | 1.6112 | 4.3 |
| 169 | 1.6112 | 1.6155 | 4.3 |
| 170 | 1.6155 | 1.6198 | 4.3 |
| 171 | 1.6198 | 1.6241 | 4.3 |
| 172 | 1.6241 | 1.6284 | 4.3 |
| 173 | 1.6284 | 1.6326 | 4.3 |
| 174 | 1.6326 | 1.6369 | 4.2 |
| 175 | 1.6369 | 1.6411 | 4.2 |
| 176 | 1.6411 | 1.6453 | 4.2 |
| 177 | 1.6453 | 1.6495 | 4.2 |
| 178 | 1.6495 | 1.6537 | 4.2 |
| 179 | 1.6537 | 1.6578 | 4.2 |
| 180 | 1.6578 | 1.6620 | 4.1 |
| 181 | 1.6620 | 1.6661 | 4.1 |
| 182 | 1.6661 | 1.6702 | 4.1 |
| 183 | 1.6702 | 1.6743 | 4.1 |
| 184 | 1.6743 | 1.6783 | 4.1 |
| 185 | 1.6783 | 1.6824 | 4.1 |
| 186 | 1.6824 | 1.6864 | 4.0 |
| 187 | 1.6864 | 1.6905 | 4.0 |
| 188 | 1.6905 | 1.6945 | 4.0 |
| 189 | 1.6945 | 1.6985 | 4.0 |
| 190 | 1.6985 | 1.7024 | 4.0 |
| 191 | 1.7024 | 1.7064 | 4.0 |
| 192 | 1.7064 | 1.7103 | 3.9 |
| 193 | 1.7103 | 1.7143 | 3.9 |
| 194 | 1.7143 | 1.7182 | 3.9 |
| 195 | 1.7182 | 1.7221 | 3.9 |
| 196 | 1.7221 | 1.7260 | 3.9 |
| 197 | 1.7260 | 1.7299 | 3.9 |
| 198 | 1.7299 | 1.7337 | 3.9 |
| 199 | 1.7337 | 1.7376 | 3.8 |

TABLE 19

| Annular | Start Position | End Position | Annular Zone |
|---|---|---|---|
| Zone No. | (mm) | (mm) | Width (μm) |
| 200 | 1.7376 | 1.7414 | 3.8 |
| 201 | 1.7414 | 1.7452 | 3.8 |
| 202 | 1.7452 | 1.7490 | 3.8 |
| 203 | 1.7490 | 1.7528 | 3.8 |
| 204 | 1.7528 | 1.7566 | 3.8 |
| 205 | 1.7566 | 1.7603 | 3.8 |
| 206 | 1.7603 | 1.7641 | 3.7 |
| 207 | 1.7641 | 1.7678 | 3.7 |
| 208 | 1.7678 | 1.7715 | 3.7 |
| 209 | 1.7715 | 1.7752 | 3.7 |
| 210 | 1.7752 | 1.7789 | 3.7 |
| 211 | 1.7789 | 1.7826 | 3.7 |
| 212 | 1.7826 | 1.7862 | 3.7 |
| 213 | 1.7862 | 1.7899 | 3.6 |
| 214 | 1.7899 | 1.7935 | 3.6 |
| 215 | 1.7935 | 1.7971 | 3.6 |
| 216 | 1.7971 | 1.8007 | 3.6 |
| 217 | 1.8007 | 1.8043 | 3.6 |
| 218 | 1.8043 | 1.8079 | 3.6 |
| 219 | 1.8079 | 1.8115 | 3.6 |
| 220 | 1.8115 | 1.8150 | 3.6 |
| 221 | 1.8150 | 1.8186 | 3.5 |
| 222 | 1.8186 | 1.8221 | 3.5 |
| 223 | 1.8221 | 1.8256 | 3.5 |
| 224 | 1.8256 | 1.8291 | 3.5 |
| 225 | 1.8291 | 1.8326 | 3.5 |
| 226 | 1.8326 | 1.8361 | 3.5 |
| 227 | 1.8361 | 1.8395 | 3.5 |
| 228 | 1.8395 | 1.8430 | 3.5 |
| 229 | 1.8430 | 1.8464 | 3.4 |
| 230 | 1.8464 | 1.8499 | 3.4 |
| 231 | 1.8499 | 1.8533 | 3.4 |
| 232 | 1.8533 | 1.8567 | 3.4 |
| 233 | 1.8567 | 1.8601 | 3.4 |
| 234 | 1.8601 | 1.8635 | 3.4 |
| 235 | 1.8635 | 1.8668 | 3.4 |
| 236 | 1.8668 | 1.8702 | 3.4 |
| 237 | 1.8702 | 1.8735 | 3.3 |
| 238 | 1.8735 | 1.8769 | 3.3 |
| 239 | 1.8769 | 1.8802 | 3.3 |
| 240 | 1.8802 | 1.8835 | 3.3 |
| 241 | 1.8835 | 1.8868 | 3.3 |
| 242 | 1.8868 | 1.8901 | 3.3 |
| 243 | 1.8901 | 1.8933 | 3.3 |
| 244 | 1.8933 | 1.8966 | 3.3 |
| 245 | 1.8966 | 1.8998 | 3.3 |
| 246 | 1.8998 | 1.9031 | 3.2 |
| 247 | 1.9031 | 1.9063 | 3.2 |
| 248 | 1.9063 | 1.9095 | 3.2 |
| 249 | 1.9095 | 1.9127 | 3.2 |

TABLE 20

| Annular | Start Position | End Position | Annular Zone |
|---|---|---|---|
| Zone No. | (mm) | (mm) | Width (μm) |
| 250 | 1.9127 | 1.9159 | 3.2 |
| 251 | 1.9159 | 1.9191 | 3.2 |
| 252 | 1.9191 | 1.9223 | 3.2 |
| 253 | 1.9223 | 1.9254 | 3.2 |
| 254 | 1.9254 | 1.9286 | 3.2 |
| 255 | 1.9286 | 1.9317 | 3.1 |
| 256 | 1.9317 | 1.9349 | 3.1 |
| 257 | 1.9349 | 1.9380 | 3.1 |
| 258 | 1.9380 | 1.9411 | 3.1 |
| 259 | 1.9411 | 1.9442 | 3.1 |
| 260 | 1.9442 | 1.9473 | 3.1 |
| 261 | 1.9473 | 1.9504 | 3.1 |
| 262 | 1.9504 | 1.9534 | 3.1 |
| 263 | 1.9534 | 1.9565 | 3.1 |
| 264 | 1.9565 | 1.9595 | 3.0 |
| 265 | 1.9595 | 1.9626 | 3.0 |
| 266 | 1.9626 | 1.9656 | 3.0 |
| 267 | 1.9656 | 1.9686 | 3.0 |
| 268 | 1.9686 | 1.9716 | 3.0 |
| 269 | 1.9716 | 1.9746 | 3.0 |
| 270 | 1.9746 | 1.9776 | 3.0 |
| 271 | 1.9776 | 1.9805 | 3.0 |
| 272 | 1.9805 | 1.9835 | 3.0 |
| 273 | 1.9835 | 1.9865 | 3.0 |
| 274 | 1.9865 | 1.9894 | 2.9 |
| 275 | 1.9894 | 1.9923 | 2.9 |
| 276 | 1.9923 | 1.9953 | 2.9 |
| 277 | 1.9953 | 1.9982 | 2.9 |
| 278 | 1.9982 | 2.0011 | 2.9 |

As shown in Table 14, P₂ is −60, and therefore the condition (4) is satisfied. However, P₂×P₄ is 90 and P₂/P₄ is 40. Therefore, the conditions (5) and (6) are not satisfied. As shown in Table 20, the annular zone (#278) through which a marginal ray passes has the width of 2.9 μm which is apparently lower than a ten-hold of the design wavelength λ.

Further, in the comparative example, SAM5 is −0.0001, CA5 is 0.0000 and SAM5-CA5 is −0.0001. Therefore, the conditions (7), (8) and (9) are not satisfied.

Since in the comparative example L10/L05 is 0.37, the condition (10) is not satisfied.

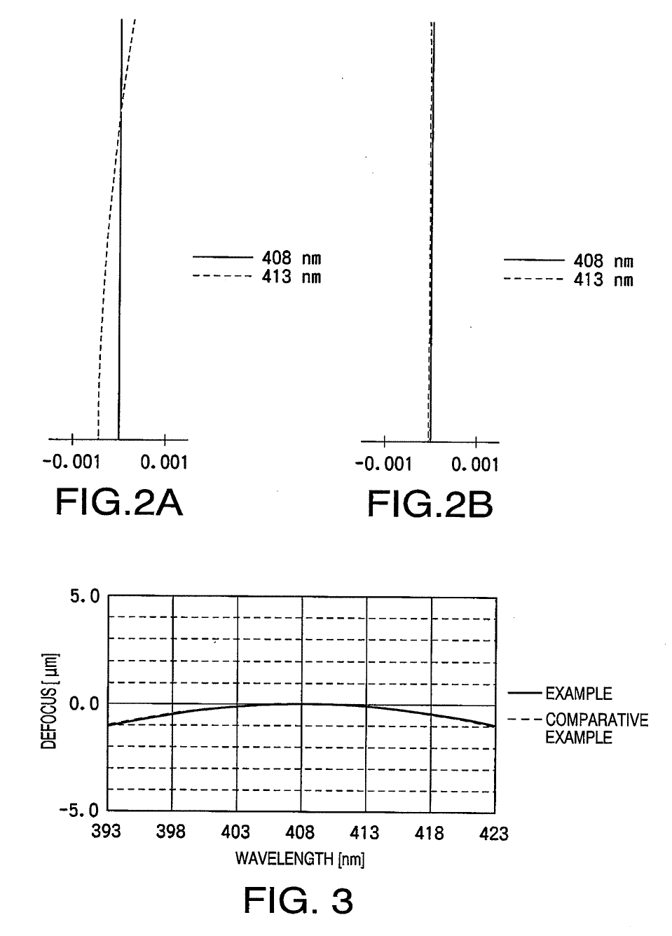

FIG. 2A is a graph illustrating the spherical aberration caused in the objective optical system 10 according to the above described example of the embodiment. FIG. 2B is a graph illustrating the spherical aberration caused in the objective optical system according to the comparative example. In each of FIGS. 2A and 2B, a curve indicated by a solid line represents the spherical aberration when the wavelength of the laser beam being used is at the design wavelength (408 nm), and a curve indicated by a dashed line represents the spherical aberration when the wavelength of the laser beam being used is at 413 nm.

FIG. 3 is a graph illustrating the longitudinal chromatic aberration for each of the above described example of the embodiment and the comparative example. In FIG. 3, the longitudinal chromatic aberration is represented as a relationship between the wavelength and the defocus amount. In FIG. 3, a curve indicated by a solid line represents the longitudinal chromatic aberration in the example of the embodiment, while a curve indicated by a dashed line represents the longitudinal chromatic aberration in the comparative example.

As shown in FIGS. 2A and 2B, due to the fact that in the objective optical system 10 according to the example the amounts of the longitudinal chromatic aberration and the spherical aberration are controlled, a relatively large amount of spherical aberration is caused in the objective optical system 100 according to the example of the embodiment in comparison with the comparative example. However, the amount of the spherical aberration is within ±0.001 mm (i.e., the spherical aberration is within the range from −0.001 to +0.001), which is negligible from a practical standpoint.

Regarding the longitudinal chromatic aberration, as shown in FIG. 3, the objective optical system 10 according to the example suitably suppresses the longitudinal chromatic aberration to a level substantially equal to the optimally corrected condition of the comparative example.

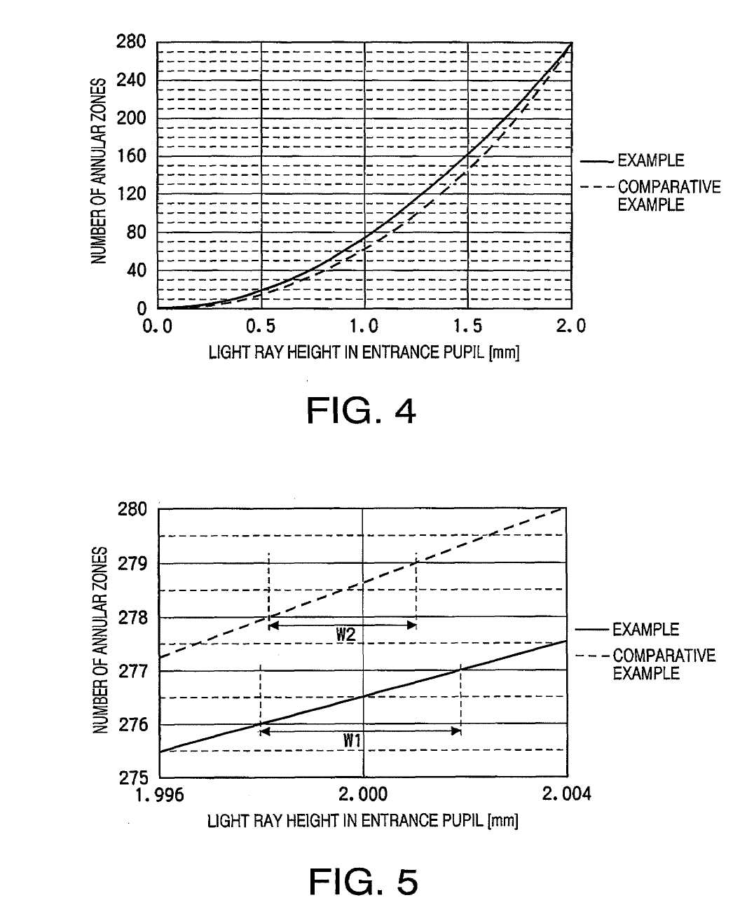

FIG. 4 shows the diffraction structure formed on the objective lens for each of the example of the embodiment and the comparative example. In FIG. 4, the diffraction structure is expressed by a relationship between the number of annular zones and the height of a light ray in the entrance pupil. FIG. 5 illustrates an enlarged view of a part of the graph shown in FIG. 4. As can be seen from FIGS. 4 and 5 and above described explanations, the width W1 of the annular zone in the peripheral portion of the objective lens 4 according to the example of the embodiment is larger than the width W2 of the annular zone in the peripheral portion of the objective lens according to the comparative example. That is, the width W1 of the annular zone in the peripheral portion of the objective lens 4 according to the example of the embodiment is set to have a value approximately equal to a ten-fold of the design wavelength λ. Therefore, the amount of light transmitted through the diffraction structure in the example of the embodiment is considerably larger than the amount of light transmitted through the diffraction structure in the comparative example. Therefore, the configuration of the example is suitable for information recording or information reproducing for the next-generation optical disc having the still higher recording density.

Although the present invention has been described in considerable detail with reference to certain preferred embodiments thereof, other embodiments are possible.

In the above described embodiment, the objective lens 4 is used as an optical element for correction of the chromatic aberration by forming the diffraction structure on the objective lens 4. However, the objective optical system may be configured to have an optical element for correction of the chromatic aberration provided separately from the objective lens.

This application claims priority of Japanese Patent Application No. P2008-030061, filed on Feb. 12, 2008. The entire subject matter of the application is incorporated herein by reference.

What is claimed is:

1. An optical element for an objective optical system mounted on an optical information recording/reproducing device for recording information to and/or reproducing information from an optical disc by letting a laser beam from a light source be incident on a record surface of the optical disc,
the objective optical system being configured to satisfy conditions:
λ<500 (1);
NA≧0.7 (2); and
f≦1.0 (3),
where λ (unit: nm) denotes a design wavelength of the laser beam emitted by the light source, NA denotes a numerical aperture on an image side, and f (unit: mm) denotes a focal length,
at least one of surfaces of the optical element including a diffraction structure defined by an optical path difference function φ(h):
φ(h)=(P₂h²+P₄h⁴+P₆h⁶+P₈h⁸+P₁₀h¹⁰+P₁₂h¹²)mλ
where P₂, P₄, P₆ . . . denote coefficients of 2^{nd} order, 4^{th} order, 6^{th} order . . . , respectively, h denotes a height from an optical axis of the optical element, and m denotes a diffraction order at which diffraction efficiency for the laser beam is maximized,
the diffraction structure satisfying conditions:
P₂<0 (4);
P₂×P₄<−100 (5); and
−60<P₂/P₄<0 (6).

2. The optical element according to claim 1,
wherein when SAM5 (unit: mm) denotes spherical aberration caused in the objective optical system for a marginal ray when a wavelength of the laser beam shifts by 5 nm from the design wavelength, and CA5 (unit: mm) denotes paraxial chromatic aberration of the objective optical system defined when the wavelength of the laser beam shifts by 5 nm from the design wavelength, the optical element satisfies conditions:
SAM5>0 (7);
CA5<0 (8); and
0<SAM5−CA5<0.001 (9).

3. The optical element according to claim 1,
wherein the diffraction structure includes a plurality of annular zones,
wherein the diffraction structure is configured to satisfy a condition:
L10/L05>0.5 (10),
where L10 denotes a width of an annular zone through which a light ray having an entrance pupil coordinate of 1.0 passes, and L05 denotes a width of an annular zone through which a light ray having an entrance pupil coordinate of 0.5 passes.

4. The optical element according to claim 1,
wherein the objective optical system satisfies a condition:
NA≧1.0 (11).

5. An objective optical system for an optical information recording/reproducing device for recording information to and/or reproducing information from an optical disc by letting a laser beam from a light source be incident on a record surface of the optical disc,
the objective optical system comprising:
an optical element; and
a hemispheric lens which is located closely with respect to the optical disc and which is arranged such that a convex surface of the hemispheric lens faces a side of the optical element,
the objective optical system being configured to satisfy conditions:
λ<500 (1);
NA≧0.7 (2); and
f≦1.0 (3),
where λ (unit: nm) denotes a design wavelength of the laser beam emitted by the light source, NA denotes a numerical aperture on an image side, and f (unit: mm) denotes a focal length,
at least one of surfaces of the optical element including a diffraction structure defined by an optical path difference function φ( ):
φ(h)=(P₂h²+P₄h⁴+P₆h⁶+P₈h⁸+P₁₀h¹⁰+P₁₂h¹²)mλ
where P₂ P₄, P₆ . . . denote coefficients of 2^{nd} order, 4^{th} order, 6^{th} order respectively, h denotes a height from an optical axis of the optical element, and m denotes a diffraction order at which diffraction efficiency for the laser beam is maximized,
the diffraction structure satisfying conditions:
P₂<0 (4);
P₂×P₄<−100 (5); and
−60<P₂/P₄<0 (6),
information recording or information reproducing for the optical disc being performed with an evanescent wave emerging from the hemispheric lens when the laser beam passed through the optical element is incident on the hemispheric lens.

6. The objective optical system according to claim 5,
wherein when SAM5 (unit: mm) denotes spherical aberration caused in the objective optical system for a marginal ray when a wavelength of the laser beam shifts by 5 nm from the design wavelength, and CA5 (unit: mm) denotes paraxial chromatic aberration of the objective optical system defined when the wavelength of the laser beam shifts by 5 nm from the design wavelength, the optical element satisfies conditions:
SAM5>0 (7);
CA5<0 (8); and
0<SAM5−CA5<0.001 (9).

7. The objective optical system according to claim 5,
wherein the diffraction structure includes a plurality of annular zones,
wherein the diffraction structure is configured to satisfy a condition:
L10/L05>0.5 (10),
where L10 denotes a width of an annular zone through which a light ray having an entrance pupil coordinate of 1.0 passes, and L05 denotes a width of an annular zone through which a light ray having an entrance pupil coordinate of 0.5 passes.

8. The objective optical system according to claim 5,
wherein the objective optical system satisfies a condition:
NA≧1.0 (11).

9. An optical information recording/reproducing device for recording information to and/or reproducing information from an optical disc, comprising:
a light source which emits a laser beam; and
an optical element,
the optical element being arranged in an objective optical system satisfying conditions:
λ<500 (1);
NA≧0.7 (2); and
f≦1.0 (3),
where λ (unit: nm) denotes a design wavelength of the laser beam emitted by the light source, NA denotes a numerical aperture on an image side, and f (unit: mm) denotes a focal length,
at least one of surfaces of the optical element including a diffraction structure defined by an optical path difference function φ(h):
φ(h)=(P₂h²+P₄h⁴+P₆h⁶+P₈h⁸+P₁₀h¹⁰+P₁₂h¹²)mλ
where P₂, P₄, P₆ . . . denote coefficients of 2^{nd} order, 4^{th} order, 6^{th} order . . . , respectively, h denotes a height from an optical axis of the optical element, and m denotes a diffraction order at which diffraction efficiency for the laser beam is maximized,
the diffraction structure satisfying conditions:
P₂<0 (4);
P₂×P₄<−100 (5); and
−60<P₂/P₄<0 (6).

10. The optical information recording/reproducing device according to claim 9,
wherein when SAM5 (unit: mm) denotes spherical aberration caused in the objective optical system for a marginal ray when a wavelength of the laser beam shifts by 5 nm from the design wavelength, and CA5 (unit: mm) denotes paraxial chromatic aberration of the objective optical system defined when the wavelength of the laser beam shifts by 5 nm from the design wavelength, the optical element satisfies conditions:
SAM5>0 (7);
CA5<0 (8); and
0<SAM5−CA5<0.001 (9).

11. The optical information recording/reproducing device according to claim 9,
wherein the diffraction structure includes a plurality of annular zones,
wherein the diffraction structure is configured to satisfy a condition:
L10/L05>0.5 (10),
where L10 denotes a width of an annular zone through which a light ray having an entrance pupil coordinate of 1.0 passes, and L05 denotes a width of an annular zone through which a light ray having an entrance pupil coordinate of 0.5 passes.

12. The optical information recording/reproducing device according to claim 9,
wherein the objective optical system satisfies a condition:
NA≧1.0 (11).

13. An optical information recording/reproducing device for recording information to and/or reproducing information from an optical disc, comprising:
a light source which emits a laser beam; and
an objective optical system,
the objective optical system comprising:
an optical element; and
a hemispheric lens which is located closely with respect to the optical disc and which is arranged such that a convex surface of the hemispheric lens faces a side of the optical element,
the objective optical system being configured to satisfy conditions:
λ<500 (1);
NA≧0.7 (2); and
f≦1.0 (3),
where λ (unit: nm) denotes a design wavelength of the laser beam emitted by the light source, NA denotes a numerical aperture on an image side, and f (unit: mm) denotes a focal length,
at least one of surfaces of the optical element including a diffraction structure defined by an optical path difference function φ(h):
φ(h)=(P₂h²+P₄h⁴+P₆h⁶+P₈h⁸+P₁₀h¹⁰+P₁₂h¹²)mλ
where P₂, P₄, P₆ . . . denote coefficients of 2^{nd} order, 4^{th} order, 6^{th} order . . . , respectively, h denotes a height from an optical axis of the optical element, and m denotes a diffraction order at which diffraction efficiency for the laser beam is maximized,
the diffraction structure satisfying conditions:
P₂<0 (4);
P₂×P₄<−100 (5); and
−60<P₂/P₄<0 (6).
information recording or information reproducing for the optical disc being performed with an evanescent wave emerging from the hemispheric lens when the laser beam passed through the optical element is incident on the hemispheric lens.

14. The optical information recording/reproducing device according to claim 13,
wherein when SAM5 (unit: mm) denotes spherical aberration caused in the objective optical system for a marginal ray when a wavelength of the laser beam shifts by 5 nm from the design wavelength, and CA5 (unit: mm) denotes paraxial chromatic aberration of the objective optical system defined when the wavelength of the laser beam shifts by 5 nm from the design wavelength, the optical element satisfies conditions:
SAM5>0 (7);
CA5<0 (8); and
0<SAM5−CA5<0.001 (9).

15. The optical information recording/reproducing device according to claim 13,
wherein the diffraction structure includes a plurality of annular zones,
wherein the diffraction structure is configured to satisfy a condition:
L10/L05>0.5 (10),
where L10 denotes a width of an annular zone through which a light ray having an entrance pupil coordinate of 1.0 passes, and L05 denotes a width of an annular zone through which a light ray having an entrance pupil coordinate of 0.5 passes.

16. The optical information recording/reproducing device according to claim 13,
wherein the objective optical system satisfies a condition:
NA≧1.0 (11).
